(19) United States
(12) Patent Application Publication
(10) Pub. No.: US 2010/0127592 A1
(43) Pub. Date: May 27, 2010

(54) STATOR-SLOT WEDGE AND DYNAMOELECTRIC-MACHINE STATOR HAVING STATOR SLOTS AND WEDGES

(75) Inventors: Johnny D. Yu, Centerville, OH (US); Joseph A. Zahora, Kettering, OH (US); Bradley S. Bryant, Xenia, OH (US)

Correspondence Address: THOMPSON HINE L.L.P.;Intellectual Property Group, P.O. BOX 8801, DAYTON, OH, 45401-8801, US

(73) Assignee: Dayton-Phoenix Group, Inc., Dayton, OH (US)

(21) Appl. No.: 12/277,413

(22) Filed: Nov. 25, 2008

(51) Int. Cl. H02K 3/493

(52) U.S. Cl. 310/214

(57) ABSTRACT

A dynamoelectric-machine stator includes a stator lamination stack, a plurality of electrically-conductive magnetic wedges, a plurality of electrically-insulative nonmagnetic wedges, and coil windings. The stator lamination stack has circumferentially-spaced-apart stator teeth. Adjacent stator teeth each have a tooth side bounding an intervening stator slot. Adjacent stator teeth each have a radially-outermost tooth tip which circumferentially projects from the corresponding tooth side into the intervening stator slot to partially close the intervening stator slot. The coil windings are randomly wound in the stator slots. The magnetic wedges are each positioned in a corresponding stator slot and physically and solid-magnetically contact the corresponding tooth tips to fully close the corresponding stator slot proximate the corresponding tooth tips. The nonmagnetic wedges are each positioned in a corresponding stator slot between the corresponding coil windings and the corresponding magnetic wedge. A stator-slot magnetic wedge of particular shape is also described.

### TECHNICAL FIELD

The present invention relates generally to dynamoelectric machines, and more particularly to a stator-slot wedge and to a dynamoelectric-machine stator having stator slots and wedges.

### BACKGROUND OF THE INVENTION

Conventional dynamoelectric machines include motors and generators having a stator lamination stack. The stator lamination stack includes outwardly-extending or inwardly-extending steel stator teeth which are circumferentially spaced apart creating a stator slot between circumferentially-adjacent stator teeth. The motor/generator also includes a rotor which surrounds the outwardly-extending stator teeth or which is surrounded by the inwardly-extending stator teeth.

The sides of a corresponding stator tooth are parallel in some small stators (such as those of some small motors and generators), and the narrowly-spaced-apart tooth sides of a corresponding stator tooth are without any performance-limiting cutouts. The tooth sides bounding an intervening stator slot taper. In some designs, adjacent teeth each have a tooth tip which circumferentially projects from the corresponding tooth side into the intervening stator slot to partially close the intervening stator slot.

Coil windings having an electrically-insulative (dielectric) coating are randomly wound in the partially-closed stator slots. An electrically-insulative (dielectric) slot liner separates the randomly wound coil windings from the surrounding steel of the stator lamination stack. An electrically-insulative (dielectric) nonmagnetic stator wedge is attached to adjacent tooth tips to fully close the corresponding stator slot to restrain the randomly wound coil windings in the corresponding stator slot.

The insulation of the randomly-wound coil windings is subject to chafing during installation and from coil movement. In the absence of the coil liner or if the stator wedge were electrically-conductive and electrically contacted the adjacent tooth tips, such chafed insulation could eventually ground (electrically ground) the motor/generator.

What is needed is an improved dynamoelectric-machine stator having stator slots and wedges.

### SUMMARY OF THE INVENTION

An expression of a first embodiment of the invention is for a dynamoelectric-machine stator including a stator lamination stack, a plurality of electrically-conductive magnetic wedges, a plurality of electrically-insulative nonmagnetic wedges, and coil windings. The stator lamination stack has a central longitudinal axis and a plurality of circumferentially spaced apart and outwardly-extending stator teeth. Adjacent stator teeth each have a tooth side bounding an intervening stator slot. The tooth sides bounding an intervening stator slot taper as one moves radially inward in the corresponding stator slot. Adjacent stator teeth each have a radially-outermost tooth tip which circumferentially projects from the corresponding tooth side into the intervening stator slot to partially close the intervening stator slot. The tooth sides of a corresponding stator tooth are planar and parallel. The coil windings are randomly wound in the stator slots. The nonmagnetic wedges are each positioned in a corresponding stator slot radially outward of the randomly-wound coil windings in the corresponding stator slot. The magnetic wedges are each positioned in a corresponding stator slot radially outward of the corresponding nonmagnetic wedge and physically and solid-magnetically contact the corresponding tooth tips to fully close the corresponding stator slot proximate the corresponding tooth tips.

An expression of a second embodiment of the invention is for a dynamoelectric-machine stator including a stator lamination stack, a plurality of electrically-conductive magnetic wedges, a plurality of electrically-insulative nonmagnetic wedges, and coil windings. The stator lamination stack has a central longitudinal axis and a plurality of circumferentially spaced apart and inwardly-extending stator teeth. Adjacent stator teeth each have a tooth side bounding an intervening stator slot. The tooth sides bounding an intervening stator slot taper as one moves radially inward in the corresponding stator slot. Adjacent stator teeth each have a radially-innermost tooth tip which circumferentially projects from the corresponding tooth side into the intervening stator slot to partially close the intervening stator slot. The tooth sides of a corresponding stator tooth are planar and parallel. The coil windings are randomly wound in the stator slots. The nonmagnetic wedges are each disposed in a corresponding stator slot radially inward of the randomly-wound coil windings in the corresponding stator slot. The magnetic wedges are each disposed in a corresponding stator slot radially inward of the corresponding nonmagnetic wedge and physically and solid-magnetically contact the corresponding tooth tips to fully close the corresponding stator slot proximate the corresponding tooth tips.

An expression of a third embodiment of the invention is for apparatus including a stator-slot electrically-conductive magnetic wedge having, as seen in an end view: a longer planar surface, a shorter planar surface which is parallel to the longer planar surface and which lacks an undercut., two planar surface portions disposed between the longer and shorter planar surfaces, and first, second, and third radius portions. The first radius portion extends from an edge of the shorter planar surface to the corresponding planar surface portion. The second radius portion extends from the corresponding planar surface portion to the third radius portion. The third radius portion extends from the second radius portion to the longer planar surface. The first radius portion is concave as seen from outside the magnetic wedge, and the second radius portion and the third radius portion each are convex as seen from outside the magnetic wedge.

Several benefits and advantages are derived from one all of the expressions of embodiments of the invention. In one example, the stator is a stator of a small motor whose stator-slot magnetic losses should be reduced and hence whose efficiency should be increased by the magnetic wedge which physically and solid-magnetically contacts the tooth tips to fully close the corresponding stator slot wherein the nonmagnetic wedge provides electrical insulation of the randomly-wound coil windings in a stator slot from the corresponding magnetic wedge.

### SUMMARY OF THE DRAWINGS

FIG. 1 is a cross-sectional view of a portion of a first embodiment of a dynamoelectric-machine stator showing two outwardly-extending stator teeth bounding an intervening stator slot containing randomly wound coil windings, an electrically-insulative nonmagnetic wedge, and a magnetic wedge;

FIG. 1A is enlarged view of the top area of the stator of FIG. 1;

FIG. 2 is a view as in FIG. 1 but with the stator slot empty;

FIG. 3 is an end view of the entire stator lamination stack of FIG. 1 with a complete set of stator teeth and stator slots and with the stator slots empty;

FIG. 4 is an enlarged perspective view of the magnetic wedge of FIG. 1;

FIG. 5 is a cross-sectional view of a portion of a second embodiment of a dynamoelectric-machine stator showing two inwardly-extending stator teeth bounding an intervening stator slot containing randomly wound coil windings, an electrically-insulative nonmagnetic wedge, and a magnetic wedge;

FIG. 6 is a view as in FIG. 5 but shown in smaller scale and with the stator slot empty;

FIG. 7 is an enlarged perspective view of the magnetic wedge of FIG. 5; and

FIG. 8 is a perspective view of an embodiment of apparatus including a stator-slot magnetic wedge.

### DETAILED DESCRIPTION

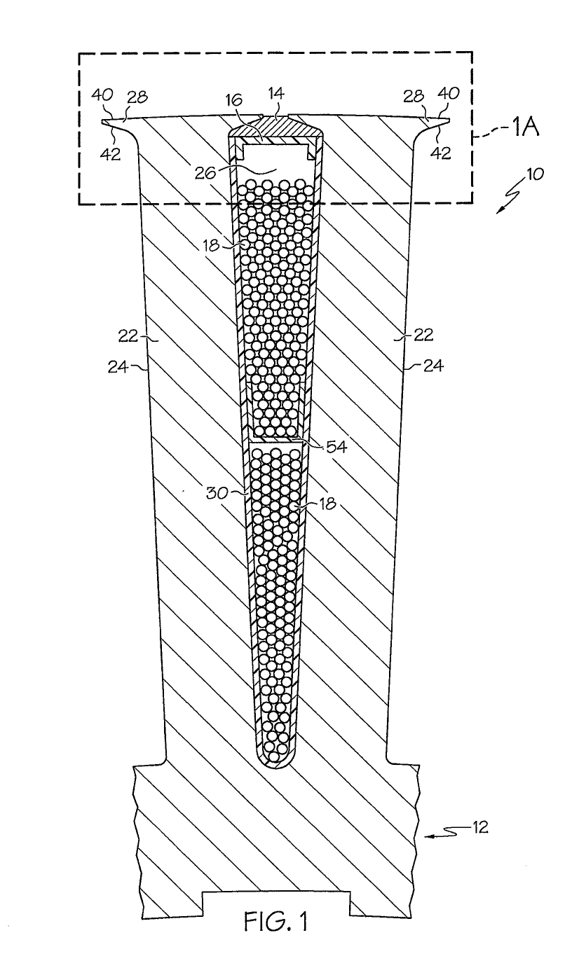

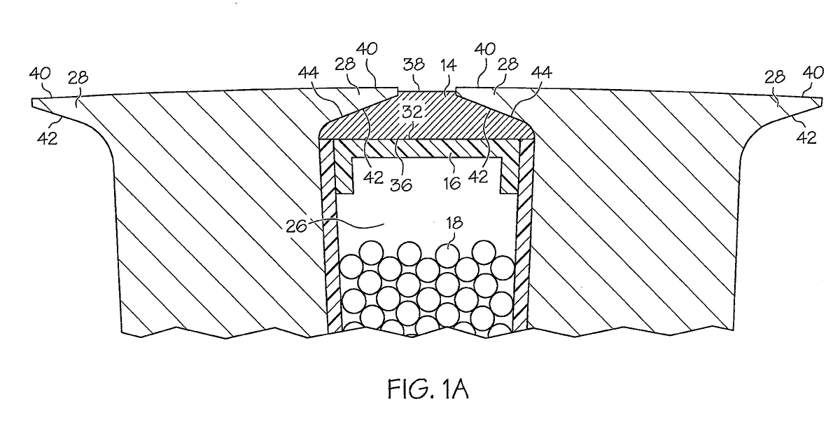

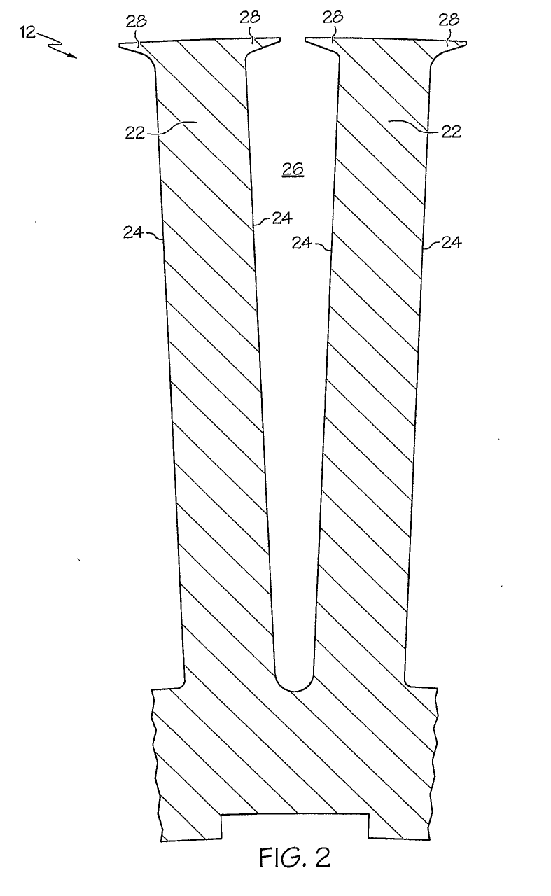

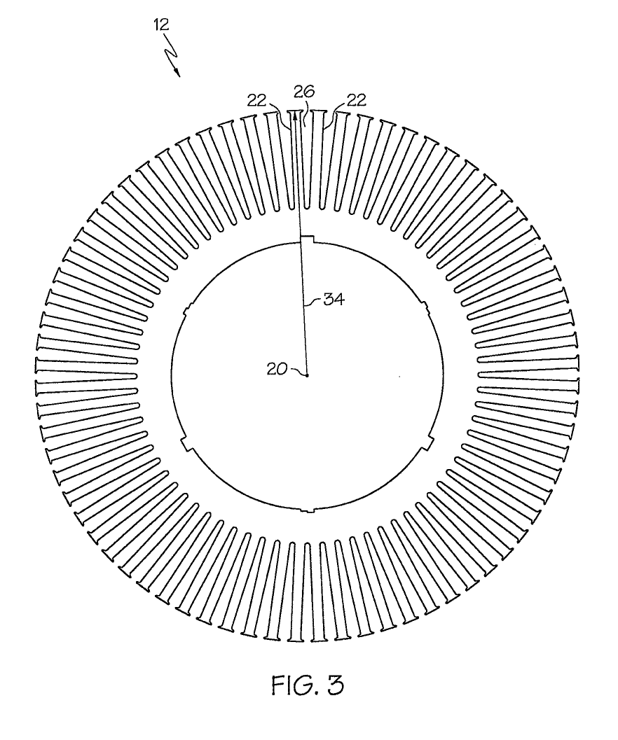

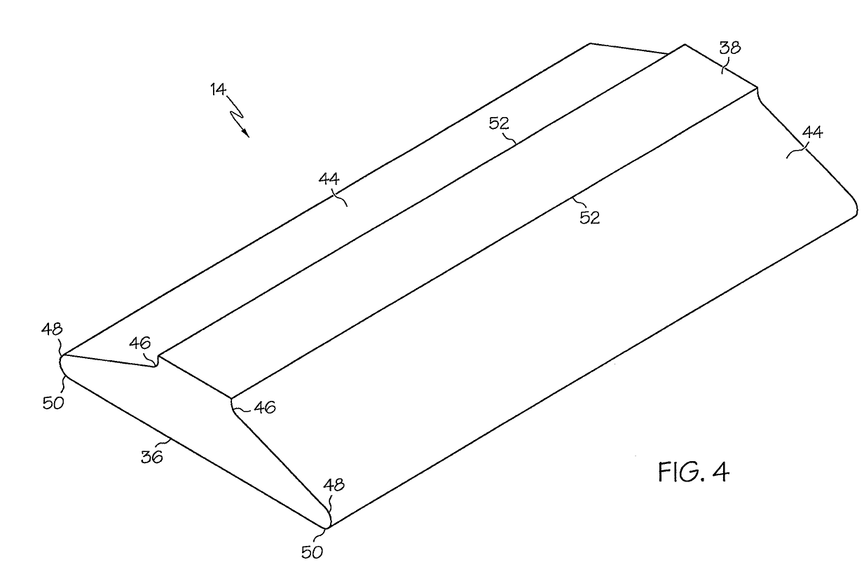

Referring now to the drawings, FIGS. 1-4 show a first embodiment of the present invention. An expression of the embodiment of FIGS. 1-4 is for a dynamoelectric-machine stator 10 including a stator lamination stack 12, a plurality of electrically-conductive magnetic wedges 14, a plurality of electrically-insulative nonmagnetic wedges 16, and coil windings 18. The stator lamination stack 12 has a central longitudinal axis 20 and a plurality of circumferentially spaced apart and outwardly-extending stator teeth 22. Adjacent stator teeth 22 each have a tooth side 24 bounding an intervening stator slot 26. The tooth sides 24 bounding an intervening stator slot 26 taper as one moves radially inward in the corresponding stator slot 26. Adjacent stator teeth 22 each have a radially-outermost tooth tip 28 which circumferentially projects from the corresponding tooth side 24 into the intervening stator slot 26 to partially close the intervening stator slot 26. The tooth sides 24 of a corresponding stator tooth 22 are planar and parallel. The coil windings 18 are randomly wound in the stator slots 26. The nonmagnetic wedges 16 are each disposed in a corresponding stator slot 26 radially outward of the randomly-wound coil windings 18 in the corresponding stator slot 26. The magnetic wedges 14 are each disposed in a corresponding stator slot 26 radially outward of the corresponding nonmagnetic wedge 16 and physically and solid-magnetically contact the corresponding tooth tips 28 to fully close the corresponding stator slot 26 proximate the corresponding tooth tips 28.

It is noted that a tooth side 24 of a stator tooth 22 does not include any circumferentially-projecting tooth tip 28 or base of the stator tooth 22. It is also noted that a tooth side having a wedge groove is not a tooth side which is planar. It is further noted that the free end of a stator tooth 22 is curved.

In one enablement of the expression of the embodiment of FIGS. 1-4, the nonmagnetic wedges 16 are disposed radially inward of the corresponding tooth tips 28. In one variation, the dynamoelectric-machine stator 10 also includes a plurality of electrically-insulative slot liners 30 each disposed in a corresponding stator slot 26 between the randomly-wound coils windings 18 of the corresponding stator slot 26 and the corresponding tooth sides 24 and each contacting the corresponding nonmagnetic wedge 16.

In one implementation of the expression of the embodiment of FIGS. 1-4, the nonmagnetic wedges 16 each have a planar, outward-facing surface 32 oriented substantially perpendicular to a radius 34 which bisects the corresponding stator slot 26. In one variation, the magnetic wedges 14 each have a planar, inward-facing surface 36 which contacts the outward-facing surface 32 of the corresponding nonmagnetic wedge 16. In one modification, the magnetic wedges 14 each have an exposed, planar, outward-facing surface 38 which is parallel to the inward-facing surface 36 of the corresponding magnetic wedge 14.

In one application of the expression of the embodiment of FIGS. 1-4, the tooth tips 28 each have an exposed, outward-facing surface 40, and the outward-facing surface 38 of the magnetic wedges 14 each are disposed radially inward of the outward-facing surface 40 of the corresponding tooth tips 28. In one variation, the outward-facing surface 38 of each magnetic wedge 14 lacks an undercut.

In one employment of the expression of the embodiment of FIGS. 1-4, the tooth tips 28 each have a planar surface portion 42 inclined from the outward-facing surface 40 of the corresponding tooth tip 28, disposed radially inward of the outward-facing surface 40 of the corresponding tooth tip 28 and radially outward of the corresponding tooth side 24. In this employment, the magnetic wedges 14 each have two planar surface portions 44 disposed radially inward of the outward-facing surface 38 of the corresponding magnetic wedge 14 and radially outward of the inward-facing surface 36 of the corresponding magnetic wedge 14. In this employment, the planar surface portions 44 of the magnetic wedges 14 each substantially completely physically and solid-magnetically contact the corresponding planar surface portion 42 of the corresponding tooth tips 28.

In one arrangement of the expression of the embodiment of FIGS. 1-4, the magnetic wedges 14 each include first, second, and third radius portions 46, 48, and 50. In this arrangement, the first radius portion 46 extends from an edge 52 of the outward-facing surface 38 of the corresponding magnetic wedge 14 to the corresponding planar surface portion 44 of the corresponding magnetic wedge 14, the second radius portion 48 extends from the corresponding planar surface portion 44 of the corresponding magnetic wedge 14 to the third radius portion 50, and the third radius portion 50 extends from the second radius portion 48 to the inward-facing surface 36 of the corresponding magnetic wedge 14. In this arrangement, the first radius portion 46 is concave as seen from outside the magnetic wedge 14, and the second radius portion 48 and the third radius portion 50 each are convex as seen from outside the magnetic wedge 14.

In one construction of the expression of the embodiment of FIGS. 1-4, an electrically-insulative nonmagnetic separator 54 is disposed in the stator slot 26 and divides the coil windings 18 into a radially-inner group and a radially-outer group. In one variation, the dynamoelectric-machine stator 10 has seventy-two stator teeth 22 and seventy-two stator slots 26. In one modification, the width of each stator tooth 22 (the distance between the tooth sides 24) is less than one-third of an inch, and the radial extent of each stator slot 26 is less than three inches.

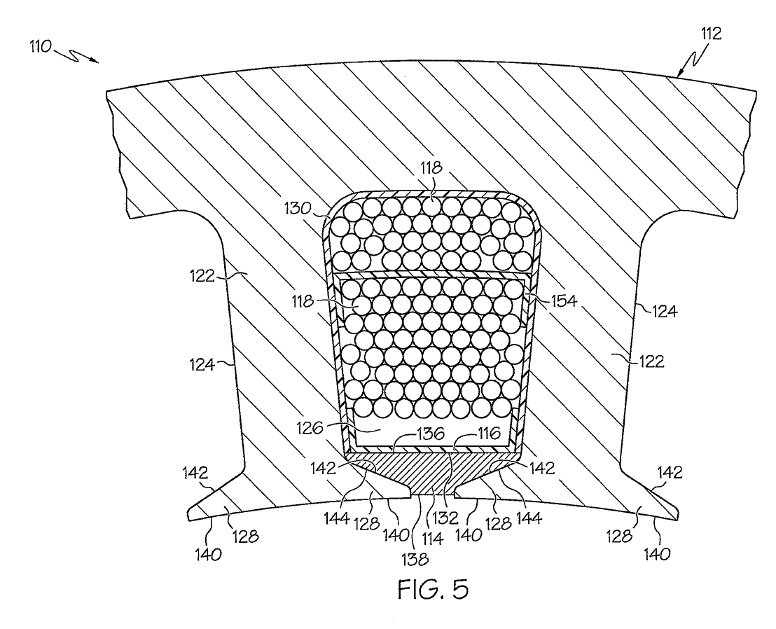

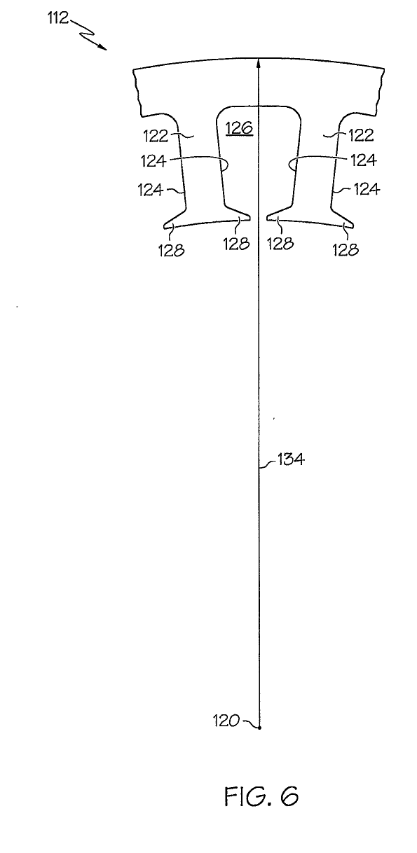

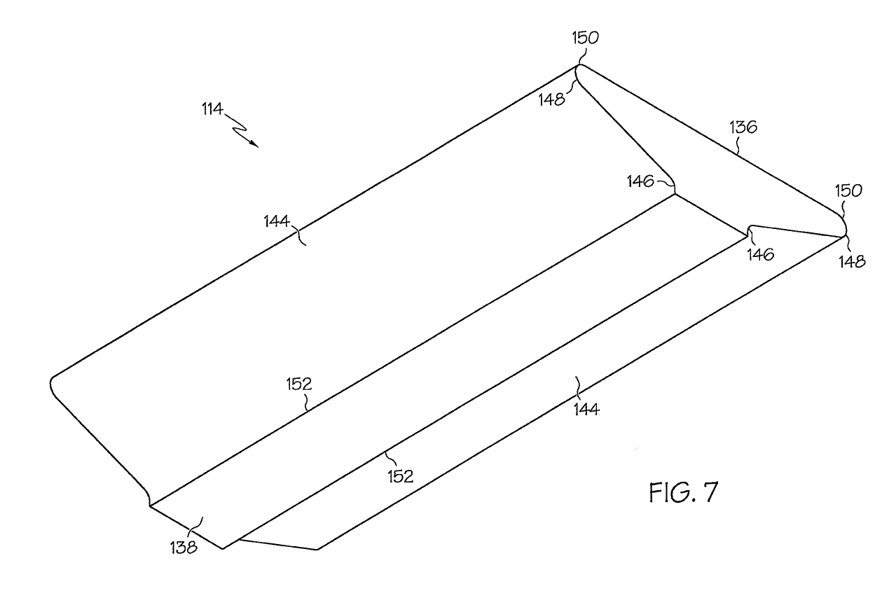

Referring again to the drawings, FIGS. 5-7 show a second embodiment of the present invention. An expression of the embodiment of FIGS. 5-8 is for a dynamoelectric-machine stator 110 including a stator lamination stack 112, a plurality of electrically-conductive magnetic wedges 114, a plurality of electrically-insulative nonmagnetic wedges 116, and coil windings 118. The stator lamination stack 112 has a central longitudinal axis 120 and a plurality of circumferentially spaced apart and inwardly-extending stator teeth 122. Adjacent stator teeth 122 each have a tooth side 124 bounding an intervening stator slot 126. The tooth sides 124 bounding an intervening stator slot 126 taper as one moves radially outward in the corresponding stator slot 126. Adjacent stator teeth 122 each have a radially-innermost tooth tip 128 which circumferentially projects from the corresponding tooth side 124 into the intervening stator slot 126 to partially close the intervening stator slot 126. The tooth sides 124 of a corresponding stator tooth 122 are planar and parallel. The coil windings 118 are randomly wound in the stator slots 126. The nonmagnetic wedges 116 are each disposed in a corresponding stator slot 126 radially inward of the randomly-wound coil windings 118 in the corresponding stator slot 126. The magnetic wedges 114 are each disposed in a corresponding stator slot 126 radially inward of the corresponding nonmagnetic wedge 116 and physically and solid-magnetically contact the corresponding tooth tips 128 to fully close the corresponding stator slot 126 proximate the corresponding tooth tips 128.

It is noted that a tooth side 124 of a stator tooth 122 does not include any circumferentially-projecting tooth tip 128 or base of the stator tooth 122. It is also noted that a tooth side having a wedge groove is not a tooth side which is planar. It is further noted that the free end of a stator tooth 122 is curved.

In one enablement of the expression of the embodiment of FIGS. 5-7, the nonmagnetic wedges 116 are disposed radially outward of the corresponding tooth tips 128. In one variation, the dynamoelectric-machine stator 110 also includes a plurality of electrically-insulative slot liners 130 each disposed in a corresponding stator slot 126 between the randomly-wound coils windings 118 of the corresponding stator slot 126 and the corresponding tooth sides 124 and each contacting the corresponding nonmagnetic wedge 116.

In one implementation of the expression of the embodiment of FIGS. 5-7, the nonmagnetic wedges 116 each have a planar, inward-facing surface 132 oriented substantially perpendicular to a radius 134 which bisects the corresponding stator slot 126. In one variation, the magnetic wedges 114 each have a planar, outward-facing surface 136 which contacts the inward-facing surface 132 of the corresponding nonmagnetic wedge 116. In one modification, the magnetic wedges 114 each have an exposed, planar, inward-facing surface 138 which is parallel to the outward-facing surface 136 of the corresponding magnetic wedge 114.

In one application of the expression of the embodiment of FIGS. 5-7 the tooth tips 128 each have an exposed, inward-facing surface 140, and the inward-facing surface 138 of the magnetic wedges 114 each are disposed radially outward of the inward-facing surface 140 of the corresponding tooth tips 128. In one variation, the inward-facing surface 138 of each magnetic wedge 114 lacks an undercut.

In one employment of the expression of the embodiment of FIGS. 5-7, the tooth tips 128 each have a planar surface portion 142 inclined from the inward-facing surface 140 of the corresponding tooth tip 128, disposed radially outward of the inward-facing surface 140 of the corresponding tooth tip 128 and radially inward of the corresponding tooth side 124. In this employment, the magnetic wedges 114 each have two planar surface portions 144 disposed radially outward of the inward-facing surface 138 of the corresponding magnetic wedge 114 and radially inward of the outward-facing surface 136 of the corresponding magnetic wedge 114. In this employment, the planar surface portions 144 of the magnetic wedges 114 each substantially completely physically and solid-magnetically contact the corresponding planar surface portion 142 of the corresponding tooth tips 128.

In one arrangement of the expression of the embodiment of FIGS. 5-7, the magnetic wedges 114 each include first, second, and third radius portions 146, 148, and 150. In this arrangement, the first radius portion 46 extends from an edge 152 of the inward-facing surface 138 of the corresponding magnetic wedge 114 to the corresponding planar surface portion 144 of the corresponding magnetic wedge 114, the second radius portion 148 extends from the corresponding planar surface portion 144 of the corresponding magnetic wedge 114 to the third radius portion 150, and the third radius portion 150 extends from the second radius portion 148 to the outward-facing surface 136 of the corresponding magnetic wedge 114. In this arrangement, the first radius portion 146 is concave as seen from outside the magnetic wedge 114, and the second radius portion 148 and the third radius portion 150 each are convex as seen from outside the magnetic wedge 114.

In one construction of the expression of the embodiment of FIGS. 5-7, an electrically-insulative nonmagnetic separator 154 is disposed in the stator slot 126 and divides the coil windings 118 into a radially-inner group and a radially-outer group. In one variation, the dynamoelectric-machine stator 110 has seventy-two stator teeth 122 and seventy-two stator slots 126. In one modification, the width of each stator tooth 122 (the distance between the tooth sides 124) is less than one-third of an inch, and the radial extent of each stator slot 126 is less than three inches.

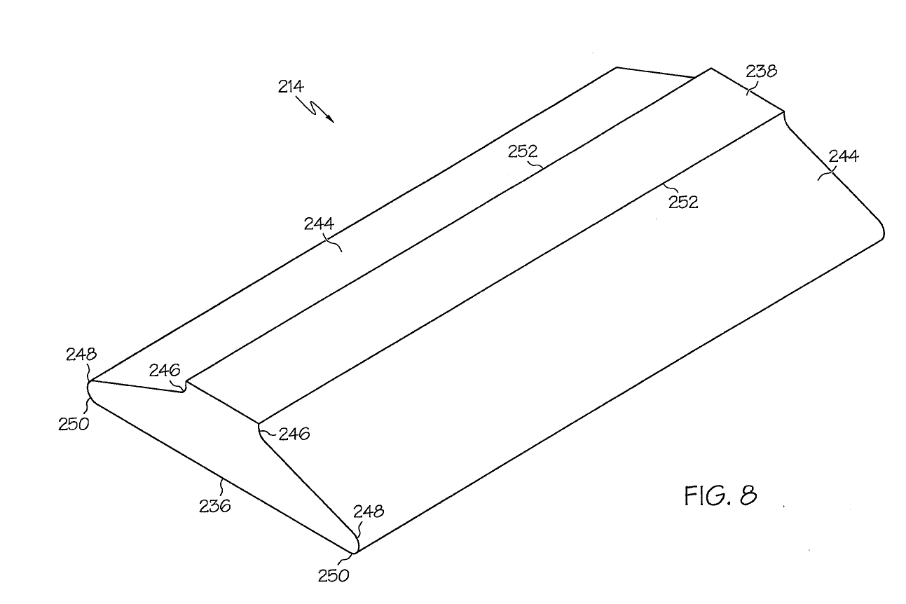

With reference to FIG. 8, an expression of a third embodiment of the present invention is for apparatus including a stator-slot electrically-conductive magnetic wedge 214 having, as seen in an end view: a longer planar surface 236, a shorter planar surface 238 which is parallel to the longer planar surface 236 and which lacks an undercut, two planar surface portions 244 disposed between the longer and shorter planar surfaces 236 and 238, and first, second, and third constant radius portions 246, 248, and 250. The first radius portion 236 extends from an edge 252 of the shorter planar surface 238 to the corresponding planar surface portion 244. The second radius portion 248 extends from the corresponding planar surface portion 244 to the third radius portion 250. The third radius portion 250 extends from the second radius portion 248 to the longer planar surface 236. The first radius portion 246 is concave as seen from outside the magnetic wedge 214, and the second radius portion 248 and the third radius portion 250 each are convex as seen from outside the magnetic wedge 214.

In one construction of the embodiment of FIG. 8, the magnetic wedge 214 comprises (and in one example consists essentially of) powdered iron. In one variation, the magnetic wedge 214, as seen in the end view, is symmetrical about a line which bisects the longer planar surface 236 and the shorter planar surface 238. In one application, the magnetic wedge 214 is used in place of magnetic wedge 14 and/or magnetic wedge 114.

Several benefits and advantages are derived from one all of the expressions of embodiments of the invention. In one example, the stator is a stator of a small motor whose stator-slot magnetic losses should be reduced and hence whose efficiency should be increased by the magnetic wedge which physically and solid-magnetically contacts the tooth tips to fully close the corresponding stator slot wherein the nonmagnetic wedge provides electrical insulation of the randomly-wound coil windings in a stator slot from the corresponding magnetic wedge.

The foregoing description of expressions of embodiments has been presented for purposes of illustration. It is not intended to be exhaustive or to limit the invention to the precise forms and steps disclosed, and obviously many modifications and variations are possible in light of the above teaching. It is intended that the scope of the invention be defined by the claims appended hereto.

1. A dynamoelectric-machine stator comprising a stator lamination stack, a plurality of electrically-conductive magnetic wedges, a plurality of electrically-insulative nonmagnetic wedges, and coil windings,
wherein the stator lamination stack has a central longitudinal axis and a plurality of circumferentially spaced apart and outwardly-extending stator teeth,
wherein adjacent stator teeth each have a tooth side bounding an intervening stator slot,
wherein the tooth sides bounding an intervening stator slot taper as one moves radially inward in the corresponding stator slot,
wherein adjacent stator teeth each have a radially-outermost tooth tip which circumferentially projects from the corresponding tooth side into the intervening stator slot to partially close the intervening stator slot,
wherein the tooth sides of a corresponding stator tooth are parallel radially inward of the corresponding tooth tips,
wherein the coil windings are randomly wound in the stator slots,
wherein the nonmagnetic wedges are each disposed in a corresponding stator slot radially outward of the randomly-wound coil windings in the corresponding stator slot, and
wherein the magnetic wedges are each disposed in a corresponding stator slot radially outward of the corresponding nonmagnetic wedge and physically and solid-magnetically contact the corresponding tooth tips to fully close the corresponding stator slot proximate the corresponding tooth tips.

2. The dynamoelectric-machine stator of claim 1, wherein the nonmagnetic wedges are disposed radially inward of the corresponding tooth tips.

3. The dynamoelectric-machine stator of claim 2, also including a plurality of electrically-insulative slot liners each disposed in a corresponding stator slot between the randomly-wound coils windings of the corresponding stator slot and the corresponding tooth sides and each contacting the corresponding nonmagnetic wedge.

4. The dynamoelectric-machine stator of claim 3, wherein the nonmagnetic wedges each have a planar, outward-facing surface oriented substantially perpendicular to a radius which bisects the corresponding stator slot.

5. The dynamoelectric-machine stator of claim 4, wherein the magnetic wedges each have a planar, inward-facing surface which contacts the outward-facing surface of the corresponding nonmagnetic wedge.

6. The dynamoelectric-machine stator of claim 5, wherein the magnetic wedges each have an exposed, planar, outward-facing surface which is parallel to the inward-facing surface of the corresponding magnetic wedge.

7. The dynamoelectric-machine stator of claim 6, wherein the tooth tips each have an exposed, outward-facing surface, and wherein the outward-facing surface of the magnetic wedges each are disposed radially inward of the outward-facing surface of the corresponding tooth tips.

8. The dynamoelectric-machine stator of claim 7, wherein the outward-facing surface of each magnetic wedge lacks an undercut.

9. The dynamoelectric-machine stator of claim 8, wherein the tooth tips each have a planar surface portion inclined from the outward-facing surface of the corresponding tooth tip, disposed radially inward of the outward-facing surface of the corresponding tooth tip and radially outward of the corresponding tooth side, wherein the magnetic wedges each have two planar surface portions disposed radially inward of the outward-facing surface of the corresponding magnetic wedge and radially outward of the inward-facing surface of the corresponding magnetic wedge, and wherein the planar surface portions of the magnetic wedges each substantially completely physically and solid-magnetically contact the corresponding planar surface portion of the corresponding tooth tips.

10. The dynamoelectric-machine stator of claim 9, wherein the magnetic wedges each include first, second, and third radius portions, wherein the first radius portion extends from an edge of the outward-facing surface of the corresponding magnetic wedge to the corresponding planar surface portion of the corresponding magnetic wedge, wherein the second radius portion extends from the corresponding planar surface portion of the corresponding magnetic wedge to the third radius portion, wherein the third radius portion extends from the second radius portion to the inward-facing surface of the corresponding magnetic wedge, wherein the first radius portion is concave as seen from outside the magnetic wedge, and wherein the second radius portion and the third radius portion each are convex as seen from outside the magnetic wedge.

11. A dynamoelectric-machine stator comprising a stator lamination stack, a plurality of electrically-conductive magnetic wedges, a plurality of electrically-insulative nonmagnetic wedges, and coil windings,
wherein the stator lamination stack has a central longitudinal axis and a plurality of circumferentially spaced apart and inwardly-extending stator teeth,
wherein adjacent stator teeth each have a tooth side bounding an intervening stator slot,
wherein the tooth sides bounding an intervening stator slot taper as one moves radially inward in the corresponding stator slot,
wherein adjacent stator teeth each have a radially-innermost tooth tip which circumferentially projects from the corresponding tooth side into the intervening stator slot to partially close the intervening stator slot,
wherein the tooth sides of a corresponding stator tooth are parallel radially inward of the corresponding tooth tips
wherein the coil windings are randomly wound in the stator slots,
wherein the nonmagnetic wedges are each disposed in a corresponding stator slot radially inward of the randomly-wound coil windings in the corresponding stator slot, and
wherein the magnetic wedges are each disposed in a corresponding stator slot radially inward of the corresponding nonmagnetic wedge and physically and solid-magnetically contact the corresponding tooth tips to fully close the corresponding stator slot proximate the corresponding tooth tips.

12. The dynamoelectric-machine stator of claim 11, wherein the nonmagnetic wedges are disposed radially outward of the corresponding tooth tips.

13. The dynamoelectric-machine stator of claim 12, also including a plurality of electrically-insulative slot liners each disposed in a corresponding stator slot between the randomly-wound coils windings of the corresponding stator slot and the corresponding tooth sides and each contacting the corresponding nonmagnetic wedge.

14. The dynamoelectric-machine stator of claim 13, wherein the nonmagnetic wedges each have a planar, inward-facing surface oriented substantially perpendicular to a radius which bisects the corresponding stator slot.

15. The dynamoelectric-machine stator of claim 14, wherein the magnetic wedges each have a planar, outward-facing surface which contacts the inward-facing surface of the corresponding nonmagnetic wedge.

16. The dynamoelectric-machine stator of claim 15, wherein the magnetic wedges each have an exposed, planar, inward-facing surface which is parallel to the outward-facing surface of the corresponding magnetic wedge.

17. The dynamoelectric-machine stator of claim 16, wherein the tooth tips each have an exposed, inward-facing surface, and wherein the inward-facing surface of the magnetic wedges each are disposed radially outward of the inward-facing surface of the corresponding tooth tips.

18. The dynamoelectric-machine stator of claim 17, wherein the inward-facing surface of each magnetic wedge lacks an undercut.

19. The dynamoelectric-machine stator of claim 18, wherein the tooth tips each have a planar surface portion inclined from the inward-facing surface of the corresponding tooth tip, disposed radially outward of the inward-facing surface of the corresponding tooth tip and radially inward of the corresponding tooth side, wherein the magnetic wedges each have two planar surface portions disposed radially outward of the inward-facing surface of the corresponding magnetic wedge and radially inward of the outward-facing surface of the corresponding magnetic wedge, and wherein the planar surface portions of the magnetic wedges each substantially completely physically and solid-magnetically contact the corresponding planar surface portion of the corresponding tooth tips.

20. The dynamoelectric-machine stator of claim 19, wherein the magnetic wedges each include first, second, and third radius portions, wherein the first radius portion extends from an edge of the inward-facing surface of the corresponding magnetic wedge to the corresponding planar surface portion of the corresponding magnetic wedge, wherein the second radius portion extends from the corresponding planar surface portion of the corresponding magnetic wedge to the third radius portion, wherein the third radius portion extends from the second radius portion to the outward-facing surface of the corresponding magnetic wedge, wherein the first radius portion is concave as seen from outside the magnetic wedge, and wherein the second radius portion and the third radius each portion are convex as seen from outside the magnetic wedge.

21. Apparatus comprising a stator-slot electrically-conductive magnetic wedge having, as seen in an end view: a longer planar surface, a shorter planar surface which is parallel to the longer planar surface and which lacks an undercut., two planar surface portions disposed between the longer and shorter planar surfaces, and first, second, and third radius portions, wherein the first radius portion extends from an edge of the shorter planar surface to the corresponding planar surface portion, wherein the second radius portion extends from the corresponding planar surface portion to the third radius portion, wherein the third radius portion extends from the second radius portion to the longer planar surface, wherein the first radius portion is concave as seen from outside the magnetic wedge, and wherein the second radius portion and the third radius portion each are convex as seen from outside the magnetic wedge.
